(19) United States
(12) Patent Application Publication
(10) Pub. No.: US 2015/0112093 A1
(43) Pub. Date: Apr. 23, 2015

(54) Use of a Fiber Reactor to Produce Silicones

(71) Applicant: Dow Corning Corporation, Midland, MI (US)

(72) Inventors: Robert Fosdick, Midland, MI (US); Parsely Simon, Midland, MI (US); Hanh Vo, Rochester, NY (US); Tylyn Weickert, Union, KY (US)

(21) Appl. No.: 14/400,032

(22) PCT Filed: May 20, 2013
(86) PCT No.: PCT/US13/41851

§ 371 Date: Nov. 10, 2014

Related U.S. Application Data
(60) Provisional application No. 61/650,806, filed on May 23, 2012.

(51) Int. Cl. C08G 77/06

(52) U.S. Cl. CPC C08G 77/06
USPC 556/450

(57) ABSTRACT

A method of reacting compounds is described. The method can include flowing a first liquid comprising a first compound into an inlet of a conduit and through a fiber bundle comprising a plurality of fibers extending lengthwise in the conduit, and flowing, while flowing the first liquid, a second liquid comprising a second compound having at least one silicon atom into the inlet of the conduit and through the fiber bundle. The method can further include reacting the first compound and the second compound within the fiber bundle to produce a third compound having at least one silicon atom different from the first and second compounds, and flowing the third compound out an outlet of the conduit.

### FIELD

This disclosure relates generally to producing silicone. More specifically, this disclosure relates to producing and polymerizing siloxane compounds.

### BACKGROUND

The statements in this section merely provide background information related to the present disclosure and may not constitute prior art.

Used in a wide range of applications and industries from automotive to personal care, siloxanes are typically made by the hydrolysis of halosilanes or organohalosilanes. The reactants can be put into a reaction vessel. The reactants may be immiscible so a mechanical stirrer may be used to disperse one reactant throughout the other reactant.

### SUMMARY

According to one aspect of the present disclosure, a method of reacting compounds is provided. The method can include flowing a first liquid comprising a first compound into an inlet of a conduit and through a fiber bundle comprising a plurality of fibers extending lengthwise in the conduit, and flowing, while flowing the first liquid, a second liquid comprising a second compound having at least one silicon atom into the inlet of the conduit and through the fiber bundle. The method can further include reacting the first compound and the second compound within the fiber bundle to produce a third compound having at least one silicon atom, and flowing the third compound out an outlet of the conduit.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic of an example fiber reactor in accordance with certain aspects of the present disclosure;

FIG. 2 is a graph of percentage of HCl as a function of Me₃SiCl in (Me₃Si)₂O;

FIG. 3 is a schematic of an example fiber reactor with a second fiber reactor in accordance with certain aspects of the present disclosure;

FIG. 4 is a photograph of a fiber reactor; and

FIG. 5 is a schematic of an example fiber reactor in accordance with certain aspects of the present disclosure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally relates to methods of using a fiber reactor for chemical reactions such as producing a siloxane or polymerizing a siloxane. The following specific embodiments are given to illustrate the design and use of the fiber reactor according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

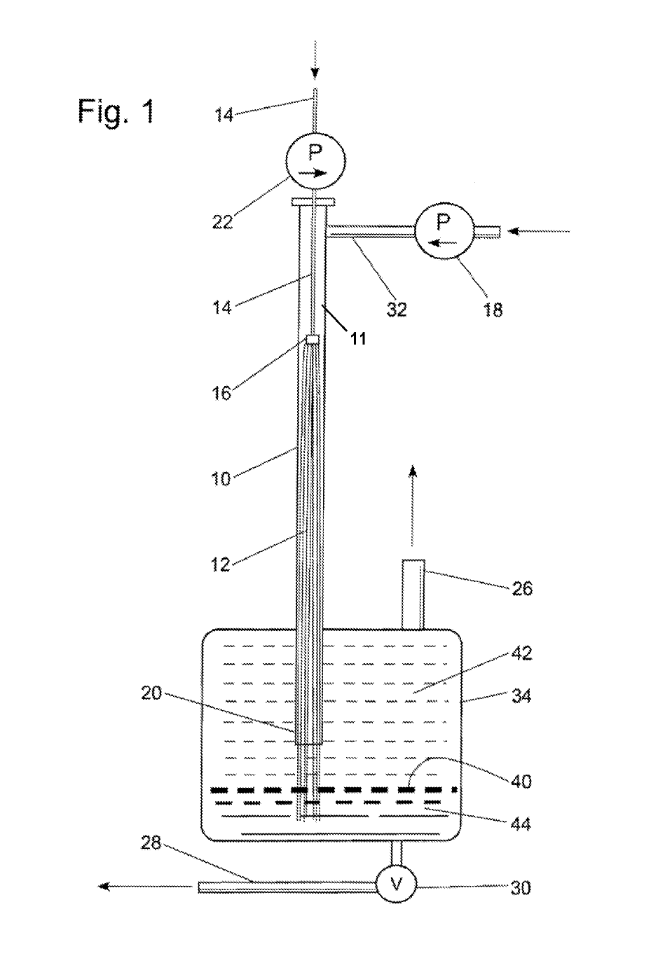

According to one aspect of the present disclosure, a method of reacting compounds is provided. For example, referring to FIG. 1, the method can include flowing a first liquid comprising a first compound into an inlet 11 of a conduit 10 and through a fiber bundle 12 comprising a plurality of fibers extending lengthwise in the conduit 10. A fiber bundle 12 can substantially fill the conduit 10 for a portion of a length of the conduit 10.

The fiber reactor 100 can further include a first pipe 14 in fluid communication with the conduit 10 to deliver the first liquid to the inlet 11 of the conduit 10. The fiber bundle 12 can be in contact with and extend into an end 16 of the first pipe 14. The first pipe 14 can extend beyond the inlet 11 of the conduit 10 and may have a metering pump 22 to pump the first liquid through the first pipe 14 and into the fiber bundle 12.

The method can further include flowing, while flowing the first liquid, a second liquid comprising a second compound having at least one silicon atom into the inlet 11 of the conduit 10 and through the fiber bundle 12. A second pipe 32 can be in fluid communication with the conduit 10 to deliver the second liquid to the inlet 11 of the conduit 10. The second pipe 32 may be fluidly connected to conduit 10 upstream of the end 16 of the first pipe 14 and may have a metering pump 18. The metering pump 18 can deliver the second liquid through the second pipe 32 and into the conduit 10, where the second liquid can flow into the fiber bundle 12. The first liquid and second liquid may be flowed into the conduit 10 by gravity or a pump.

The fibers in the fiber bundle 12 can be a plurality of fibers extending lengthwise in the conduit 10. The fibers can be selected to be preferentially wetted by the first liquid versus the second liquid or be selected to be preferentially wetted by the second liquid versus the first liquid, which is further described below. The fibers may also be selected so that the fibers do not add contaminates to the liquids that flow through the fiber bundle 12. The fibers may further be able to withstand the process to prevent frequent replacement. Examples of fibers include, but are not limited to, fibers comprising cotton, jute, silk, treated minerals, untreated minerals, metals, metal alloys, treated carbon, untreated carbon, polymers, and polymer blends. Suitable treated or untreated mineral fibers include, but are not limited to, fibers of glass, asbestos, ceramics, and combinations thereof. Suitable metal fibers include, but are not limited to, fibers of iron, steel, nickel, copper, brass, lead, tin, zinc, cobalt, titanium, tungsten, nichrome, silver, aluminum, magnesium, and alloys thereof. Suitable polymer fibers include, but are not limited to, fibers of hydrophilic polymers, polar polymers, hydrophilic copolymers, polar copolymers, and combinations thereof, such as polysaccharides, polypeptides, polyacrylic acid, polymethacrylic acid, functionalized polystyrene (including sulfonated polystyrene and aminated polystyrene), nylon, polybenzimidazole, polyvinylidenedinitrile, polyvinylidene chloride, polyphenylene sulfide, polymelamine, polyvinyl chloride, co-polyethylene-acrylic acid and ethylene-vinyl alcohol copolymers. In one embodiment, the fibers comprise glass or steel fibers.

The diameter of the fibers forming the fiber bundle can be from about 1 to about 100 μm, from about 5 to about 25 μm, or from about 8 to about 12 μm. Combinations of fibers may also be employed.

The fiber bundle 12 may be formed in the conduit 10 by a various methods. For example, a group of the fibers may be hooked at the middle along the length of the fibers with a wire and pulled into the conduit 10 using the wire.

The conduit 10 can be cylindrically shaped and comprised of a non-reactive material such as stainless steel or Teflon. The conduit 10 can be part of a mass transfer apparatus comprising fibers.

The method can further include reacting the first compound and the second compound (e.g., reactants) within the fiber bundle 12 to produce a third compound (e.g., product) having at least one silicon atom and flowing the third compound out an outlet 20 of the conduit 10. The third compound may be different from first and second compounds.

The chemical reaction can result in one or more liquids that comprise products from the chemical reaction that can flow out of the fiber bundle 12 and out an outlet 20 of the conduit 10. For example, the method may include forming a third liquid comprising the third compound within the fiber bundle 12 and flowing the third liquid out the outlet 20 of the conduit 10. In addition, the method may further include forming a fourth liquid within the fiber bundle and flowing the fourth liquid out the outlet of the conduit. As a result of the chemical reaction, the third and fourth liquids can have different compositions and/or compounds than the first and second liquids.

Many chemical reactions can occur at a faster rate when the reactants are mixed or agitated. For example, the first liquid and the second liquid may be substantially immiscible. The plurality of fibers may be selected to be preferentially wetted by the first liquid than the second liquid. For example, the first liquid may wet the fiber of the fiber bundle 12 which can increase surface interface between the first liquid and the second liquid thereby increasing the chemical reaction rate. Alternatively, the plurality of fibers may be selected to be preferentially wetted by the second liquid than the first liquid.

The viscosity of the first and second liquid can be sufficient for the first and/or second liquids to flow through the conduit 10. For example, the viscosity of the first and/or second liquid may be less than about 500 centistokes (cSt), from about 0.1 to about 500 cSt, from about 0.1 to about 100 cSt, from about 0.1 to about 50 cSt, or from about 0.1 to about 10 cSt, at 25° C.

The volumetric flow ratio of the second liquid to the first liquid can be at least about 0.1, from about 0.1 to about 20, from about 1 to about 4, about 3. As used herein, “volumetric flow ratio” means the ratio of the volumetric flow rate of the second liquid to that of the first liquid.

The first and second liquid can be introduced into the conduit 10 with a variety of temperatures and pressures. For example, the first and second liquid may have a temperature of about room temperature when introduced into the conduit. The chemical reaction of the first and second liquid may be exothermic which can raise the temperature or endothermic which can lower the temperature of the first and second liquid in the fiber bundle 12. As such, the conduit 10 may also equipped with means of controlling the temperature within the fiber bundle 12. For example, the conduit may be equipped with a heat exchanger or a heating jacket.

The first and second liquid may have a residence time in the fiber bundle 12 that is sufficient to have the chemical reaction go to substantial completion. For example, a sufficient residence time may be at least 5 s, alternatively from 5 s to 30 minutes, alternatively from 30 s to 15 min, or alternatively from 1 min to 10 min. As used herein, “residence time” means the time for one conduit volume (e.g., the volume of liquid that can fill the conduit comprising the fiber bundles) of the first liquid and second liquid together to pass through the conduit containing fibers.

The method can further include collecting the third liquid and the fourth liquid in a collection vessel 34. The collection vessel 34 may be a gravity separator or settling tank or any other vessel that will allow for the collection and separation of the first and second liquids exiting the conduit 10. The outlet 20 of the conduit 10 may be in fluid communication with the collection vessel 34 downstream of the conduit 10 to receive the third and fourth liquids. Furthermore, the fiber bundle 12 may extend out of the outlet 20 of the conduit 10, and a portion of the conduit 10 and/or the fiber bundle 12 may extend into the collection vessel 34. The third and fourth liquids can flow into the collection vessel 34 and can form a first layer 42 and a second layer 44, respectively. As such, the third and fourth liquids may be substantially immiscible. Fiber bundle 12 may extend into the first layer 42 and/or the second layer 44. However, the position of the first layer 42 and second layer 44 in the collection vessel 34 may be reversed.

The collection vessel 34 can include a first outlet line 26 in an upper portion of the collection vessel 34 where the third liquid of the first layer 42 can flow out of the collection vessel 34. The collection vessel 34 can also include a second outlet line 28 in a lower portion of the collection vessel 34 where the fourth liquid of the second layer 44 can flow out of the collection vessel 34. A metering valve 30 may also be included with the second outlet line 28 to control flow rate of the fourth liquid of the second layer 44. Although not shown in FIG. 1, the first outlet line 26 may also include a metering valve to control flow rate of the third liquid of the first layer 42. The collection of the third and fourth liquids can be done or occur while the flowing of the first and second liquids through the conduit 10.

The first layer 42 and the second layer 44 can then be separated. The first layer 42 and the second layer 44 can separate spontaneous such as a result of the third and fourth liquids having different masses and being immiscible. The first layer 42 and the second layer 44 may be removed separately from the collection vessel 34. The first layer 42 and second layer 44 may be withdrawn from the collection vessel with the aid of a pump.

After collection of the third liquid, the third liquid (e.g., siloxane) may be sent through the same or similar reactor or another apparatus to remove impurities. For example, the third liquid along with a fifth liquid can be flown through a fiber reactor that is the same or similar to the fiber reactor 100 of FIG. 1. As such, the method can include flowing a fifth liquid into an inlet of a second conduit and through a second fiber bundle comprising a plurality of fibers extending lengthwise in the second conduit and flowing, while flowing the fifth liquid, the third liquid into the inlet of the second conduit and through the second fiber bundle. The fifth liquid may, for example, comprise water.

According to one aspect of the present disclosure, siloxane can be produced by the chemical reaction in the fiber bundle 12. For example, the first compound may comprise water, the second compound may comprise at least one halosilane (e.g., chlorosilane), and the third compound may comprise siloxane.

The halosilane may have the formula RₐSiX₄₋ₐ, wherein each R is as described and exemplified above, X is C₁-C₈ alkoxy or halo, for example, chloro, bromo, or iodo, and a is an integer from 0 to 3. The alkoxy groups represented by X may have from 1 to 8 carbon atoms, alternatively from 1 to 4 carbon atoms. Examples of alkoxy groups include, but are not limited to methoxy, ethoxy, propoxy, and butoxy.

Examples of halosilanes that can be hydrolyzed to make the siloxane include, but are not limited to, diorganodihalosilane compounds such as dimethyldichlorosilane (CH₃)₂SiCl₂, diethyldichlorosilane (C₂H₅)₂SiCl₂, di-n-propyldichlorosilane (n-C₃H₇)₂SiCl₂, di-i-propyldichlorosilane (i-C₃H₇)₂SiCl₂, di-n-butyldichlorosilane (n-C₄H₉)₂SiCl₂, di-i-butyldichlorosilane (i-C₄H₉)₂SiCl₂), di-t-butyldichlorosilane (t-C₄H₉)₂SiCl₂), n-butylmethyldichlorosilane CH₃(n-C₄H₉)SiCl₂, octadecylmethyldichlorosilane CH₃(C₁₈H₃₇)SiCl₂, diphenyldichlorosilane (C₆H₅)₂SiCl₂, phenylmethyldichlorosilane CH₃(C₆H₅)SiCl₂ and dicyclohexyldichlorosilane (C₈H₁₁)₂SiCl₂; organohydrodihalosilane compounds such as methyldichlorosilane, CH₃HSiCl₂, and any of the diorganodihalosilanes listed above in which one of the alkyl substituents is replaced by hydrogen; triorganohalosilane compounds such as trimethylchlorosilane (CH₃)₃SiCl; and organotrihalosilane compounds such as methyltrichlorosilane.

The second compound may comprise at least one chlorosilane. Chlorosilane is a compound comprising at least one silicon-chlorine bond. Chlorosilanes can include, for example, monochlorosilane, dichlorosilane, trichlorosilane, and tetrachlorosilane. Chlorosilanes can react with water through a hydration reaction to produce hydrogen chloride with the remaining hydroxyl group bonding to the silicon. As such, the reacting of the first compound and the second compound may further produce a fourth compound comprising hydrogen chloride. An example of hydration of monochlorosilane is: 2Me₃SiCl+H₂O⇄ Me₃SiOSiMe₃+2HCl, where Me is a methyl group. The chlorosilane may be a single chlorosilane or a mixture of chlorosilanes. According to one aspect of the present disclosure, the chlorosilane includes dimethylvinylchlorosilane. Additional examples of chlorosilanes include methylstrichlorosilane, dimethyldichlorosilane, trimethylchlorosilane, and hydrosilanes such as dimethylhydrochlorosilane.

The first liquid may also include a solvent. For example, a solvent may comprise aromatic or straight chains. Examples of solvents include xylene, hexane, and heptane.

Furthermore, from the chemical reaction, a third liquid can be produced comprising the third compound and a fourth liquid can be produced comprising the fourth compound. The third and fourth liquids can flow out the outlet 20 of the conduit 10 and into a collection vessel 34.

Furthermore, hydrogen chloride may be dissolved in water and may also form a gas. For example, if too much hydrogen chloride is produced to be able to be dissolved in water, hydrogen chloride gas may form. Therefore, a gas comprising hydrogen chloride may also be flown out the outlet 20 of the conduit 10 and into the collection vessel 34. Hydrogen chloride gas may then be vented from the collection vessel 34.

The first and/or second compounds may be substantially reacted such that the third and fourth liquids substantially do not include the first and/or second compounds. For example, substantially all of the chlorosilane reacts with the water such that the third liquid may have substantially no chlorosilane such as a concentration of less than about 3% chlorosilane. Furthermore, the third liquid may have substantially no hydrogen chloride such as a concentration of less than about 100 ppm or less than about 10 ppm.

Siloxane is a compound containing at least one Si—O—Si linkage and may be a solid or a liquid. There is typically no limit on the viscosity or molecular weight of the siloxane. For example the molecular weight of the siloxane may be at least 75 grams/mole, alternatively at least 500 grams/mole, alternatively from 500 to 25,000 grams/mole. At least one silicon atom in the siloxane may be substituted with an element selected from carbon, boron, aluminum, titanium, tin, lead, phosphorus, arsenic, and other elements. The siloxane may be a single siloxane or a mixture of siloxanes.

The siloxane may be a disiloxane, a trisiloxane, or other polysiloxane. According to one aspect of the present disclosure, the siloxane includes hexamethyldisiloxane. Polysiloxane compositions may have a linear, branched, cyclic, or cross-linked (e.g., resinous) structure and are typically hydroxy- or methyl-endblocked.

Polysiloxanes are polymers having siloxy units independently selected from (R₃SiO_{1/2}), (R₂SiO_{2/2}), (RSiO_{3/2}), or (SiO_{4/2}) siloxy units, where each R independently may be H or any monovalent organic group, alternatively each R is independently H, hydrocarbyl containing 1 to 20 carbon atoms, or substituted hydrocarbyl containing 1 to 20 carbon atoms, alternatively each R is independently an alkyl group containing 1 to 20 carbon atoms, alternatively R is methyl. These siloxy units are commonly referred to as M, D, T, and Q units respectively. Their molecular structures are listed below:

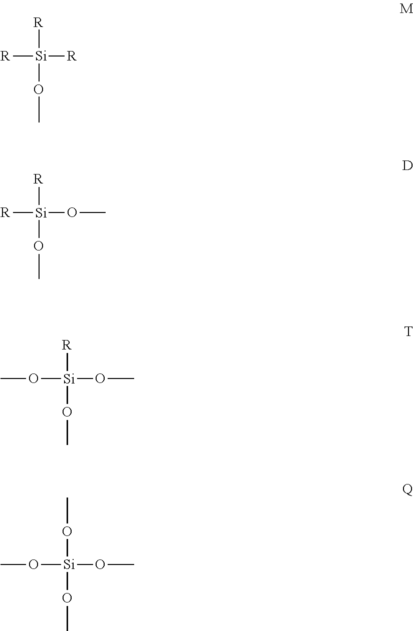

The polysiloxane may be a silicone fluid, a silicone resin, or an organosilicon polymer. The polysiloxane may have at least some portion that may be considered as an organopolysiloxane segment. Silicone fluids and silicone resins that may have structural units according to the formula (RₙSi—O_{(4-n)/2}), where n has an average value of at least 2 for silicone fluids and less than 2 for silicone resins and R is as described above; organosilicon copolymers may have structural units according to the formulas (RₙSi—O_{(4-n)/2}), where n is from 0 to 3 and R is as described above, and (CR₂), where R is as defined and exemplified above.

The hydrocarbyl groups represented by R may have from 1 to 20 carbon atoms, alternatively from 1 to 10 carbon atoms, or alternatively from 1 to 4 carbon atoms. Acyclic hydrocarbyl groups having at least three carbon atoms can have a branched or unbranched structure. Examples of hydrocarbyl groups include, but are not limited to, alkyl such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl such as cyclopentyl, cyclohexyl, and methylcyclohexyl; aryl such as phenyl or naphthyl; alkenyl groups such as vinyl, allyl, 5-hexenyl, and cyclohexenyl; alkaryl such as tolyl and xylyl, arylalkyl such as benzyl, phenethyl, phenpropyl, and phenylhexyl; and aralkenyl, such as styryl and cinnamyl, and alkynyl, such as ethynyl and propynyl. One skilled in the art will appreciate that some of the R groups on the organopolysiloxanes units described above may be groups other than those specifically defined above, such as, for example, hydroxyl groups in the case of hydroxyl end-blocking.

The substituted hydrocarbyl groups represented by R may have from 1 to 20 carbon atoms, alternatively from 1 to 10 carbon atoms, alternatively from 1 to 4 carbon atoms. Examples of the substituted hydrocarbyl groups include, but are not limited to, the hydrocarbyl groups described and exemplified above for R substituted with a substituent. Examples of a substituent include, but are not limited to —F, —Cl, —Br, —I, —OH, —OCH₃, —OCH₂CH₃, —OCH₂CH₂OCH₂CH₃, and fluorocarbons including, for example 3,3,3-trifluoropropyl groups —CF₃.

Examples of the polysiloxane include, but are not limited to, trimethylsiloxy-terminated polydimethylsiloxane, triethylsiloxy-terminated polydimethylsiloxane, dimethylhydroxysiloxy-terminated polydimethylsiloxane, diethylhydroxysiloxy-terminated polydimethylsiloxane, diphenyl(methyl)siloxy-terminated polymethyl(phenyl)siloxane, trimethylsiloxy-terminated polydimethylsiloxane-polymethylvinylsiloxane copolymers, vinyldimethylsiloxy-terminated polydimethylsiloxane-polymethylvinylsiloxane copolymers, trimethylsiloxy-terminated polydimethylsiloxane-polymethylhexenylsiloxane copolymers, hexenyldimethylsiloxy-terminated polydimethylsiloxane-polymethylhexenylsiloxane copolymers, vinyldimethylsiloxy-terminated polydimethylsiloxane-polymethyhexenylsiloxane copolymers, trimethylsiloxy-terminated polymethylvinylsiloxane polymers, trimethylsiloxy-terminated polymethylhexenylsiloxane polymers, vinyldimethylsiloxy-terminated polydimethylsiloxane polymers, and hexenyldimethylsiloxy-terminated polydimethylsiloxane polymers, vinyldimethylsiloxy-terminated poly(dimethylsiloxane-monomethylsilsesquioxane) polymers, trimethylsiloxy-terminated poly(dimethylsiloxane-methylsilsesquioxane) copolymers, vinyldimethylsiloxy-terminated poly(dimethylsiloxane-vinylmethylsiloxane-methylsilsesquioxane) copolymers; trimethylsiloxy terminated poly(dimethylsiloxane-vinylmethylsiloxane-methylsilsesquioxane) polymers, hexenyldimethylsiloxy terminated poly(dimethylsiloxane-monomethylsilsesquioxane) polymers, hexenyldimethylsiloxy terminated poly(dimethylsiloxane-hexenylmethylsiloxane-methylsilsesquioxane) copolymers, trimethylsiloxy terminated poly(dimethylsiloxane-hexenylmethylsiloxane-methylsilsesquioxane) polymers, vinyldimethylsiloxy terminated poly(dimethylsiloxane-silicate) copolymers, hexenyldimethylsiloxy-terminated poly(dimethylsiloxane-silicate) copolymers, trimethylsiloxy terminated poly(dimethylsiloxane-vinylmethylsiloxane-silicate) copolymers and trimethylsiloxy terminated poly(dimethylsiloxane-hexenylmethylsiloxane-silicate) copolymers, vinylsiloxy or hexenylsiloxy terminated poly(dimethylsiloxane-hydrocarbylene copolymers), vinylsiloxy terminated or hexenylsiloxy terminated poly(dimethylsiloxane-polyoxyalkylene) block copolymers, alkenyloxydimethylsiloxy terminated polyisobutylene, alkenyloxydimethylsiloxy terminated polydimethylsiloxane-polyisobutylene block copolymers, hexamethylcyclotrisiloxane, octamethylcyclotetrasiloxane, decamethylcyclopentasiloxane, dodecamethylcyclohexasiloxane, and polysilylenesiloxanes, such as trimethylsilyl- and trimethylsiloxy-terminated polysilylenedimethylsiloxane.

According to one aspect of the present disclosure, polymerization of siloxane in the fiber bundle 12 can result in longer chain siloxanes. The first compound may comprise a catalyst such as aqueous hydrochloric acid. The second compound may comprise at least one siloxane having a first number average molar mass. The siloxane can be any as those described above. For example, the at least one siloxane may comprise dimethyl cyclic siloxane and chlorine endblocked dimethyl siloxane. The reacting the first compound and the second compound can comprise polymerizing. As such, the third compound can comprise a polymerized siloxane having a second number average molar mass greater than the first number average molar mass. The resulting polymerized siloxane can also be any siloxane described above.

After the polymerization, a third and fourth liquid can be flown out the outlet 20 of the conduit 10. The third liquid can include an aqueous hydrochloric acid. For example, the aqueous hydrochloric acid may be the same or substantially similar to the aqueous hydrochloric acid of the first liquid. The forth liquid can include the polymerized siloxane.

The siloxanes produced by the processes described herein may be used in established industries from the personal care to the automotive industries.

The following examples are provided to demonstrate the benefits of the disclosed methods of using fiber reactors for chemical reactions. Furthermore, all described percent concentrations are in weight percentage unless otherwise stated.

### Example 1

### Hydrolysis Reactions with Chlorosilanes

Hydrolysis of trimethylchlorosilane (Me₃SiCl) to form hexamethyldisiloxane was conducted. In addition, hydrolysis of dimethylvinylchlorosilane was also conducted to show that various monochlorosilanes can be hydrolyzed using a fiber reactor.

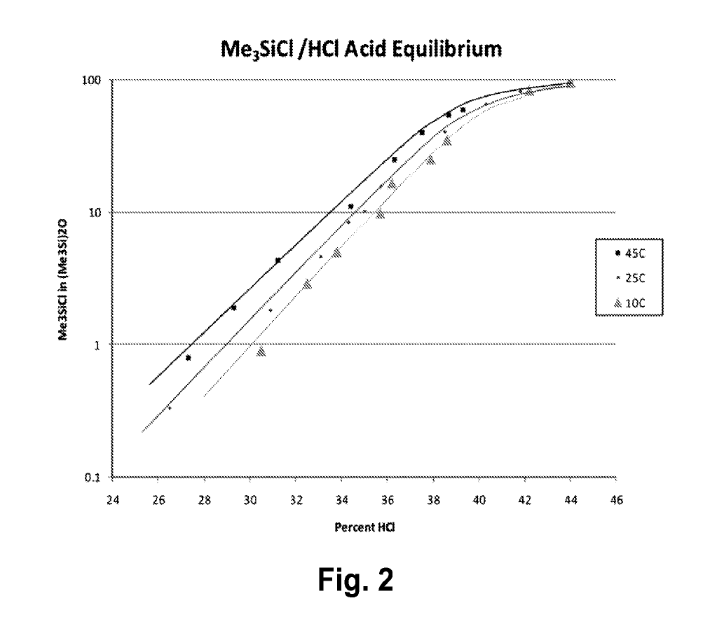

During the hydrolysis, the HCl generated dissolves in the excess water. Because water can only absorb up to ˜37% HCl concentration, a significant amount of excess water may be required. The monochlorosilane hydrolysis reaction is reversible, as is shown in Equation 1. Temperature and percent HCl in the final water solution influence this reaction. Higher temperatures move the reaction to the left hand side, just as HCl concentration. At the 24% HCl concentration, conversion is almost complete (see FIG. 2).

2Me₃SiCl+H₂O⇄Me₃SiOSiMe₃+2HCl Eq. 1

Hydrogen chloride dissolution into water generates an exothermic heat of solution. Thus, with Eq. 1 producing HCl which will be by design dissolved into water, an increase in temperature will be expected. The heat of reaction plus the heat of solution has been calculated. Trimethylchlorosilane boils at 57° C., which could result in raw material boiling during the experiment. Pre-experiment calculations were completed to determine the desired water flow rate to achieve the target % HCl concentration in the remaining water, along with the estimated temperature increase.

An indication that the reaction was taking place would be if the reactor product was warmer than the feed. Next, determination of the extent of reaction would be made. This would be completed by acid content and/or gas chromatography (GC) analysis of the material, identifying the raw material and product content.

To test the fiber reactor for the hydrolysis of monochlorosilanes, trimethylchlorosilane was used. The water and chlorosilanes were run at flow rates that would give the desired HCl concentration. The first test was run to a concentration of roughly 12% HCl concentration to understand the temperature increase experimentally.

The first experiment was conducted for a brief time and performed well. The reaction appeared to be complete within 30 seconds based on the temperature within the tube. The purity was measured by local GC and found to match a production tested sample. The estimated acid concentration was ˜12% and at the same time, the amount of HCl measured in the reacted silicone was 3.7 ppm.

The third experiment was conducted to test the run at 25% HCl. Similar feed rates of the input materials was used as above, but the water flow was decreased to produce the 25% HCl concentration. Some small amount of gas was observed within the fiber reactor. This was believed to be HCl. Flow rates, although steady, are not well distributed within the fiber reactor and channeling may exist.

Final product quality was good but there was a noticeable increase in Me₃SiCl in the product. The Me₃SiCl concentration versus HCl concentration matches well the data plotted in FIG. 2.

Two more experiments were conducted at the higher HCl concentration for observations of the gas bubble formation and to conduct specification testing. The refractive index (RI) testing was difficult as the measurement would drift which may be caused by the residual Me₃SiCl.

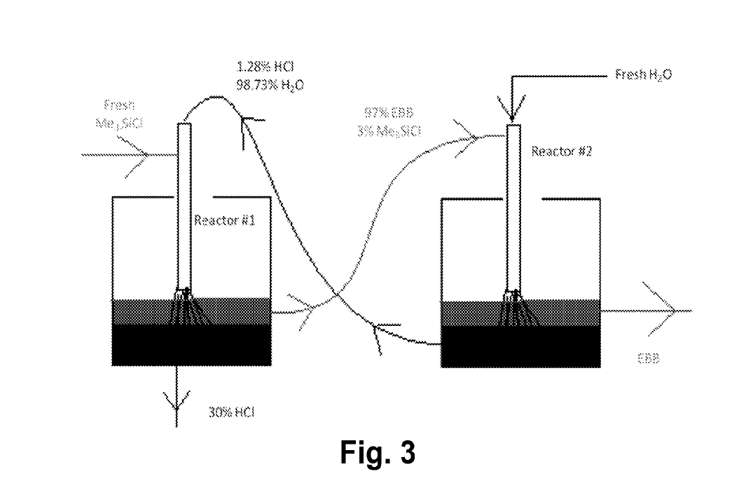

Approaching a higher HCl concentration was of interest. Me₃SiCl concentrations in the hexamethyldisiloxane would be expected to increase and may not be acceptable. However, a second fiber reactor was used to remove residual Me₃SiCl. The concept was to increase the aqueous HCl concentration to roughly 30% knowing that the reaction would not go to completion, but produce a stream that would be more desirable for HCl recovery. A second fiber reactor would be installed to react the residual Me₃SiCl contained within the hexamethyldisiloxane, as shown in FIG. 3.

Based on FIG. 2, there could be roughly 3% Me₃SiCl in equilibrium with the hexamethyldisiloxane phase that would get sent to the second reactor. Reaction water, for Fiber Reactor #1 to react the feed chlorosilane and generate a 30% HCl concentration, would first be fed into Reactor #2. Three experiments were conducted following this concept. The first experiment utilized only one reactor, but operated it first as a chlorosilane reactor, and then the second pass was a washing reactor. Chlorosilane contamination was believed to have occurred, and the final chloride concentration was higher than desired. Product purity was good.

To combat the contamination problem, a physical second reactor was built. This reactor was packed with more fibers than the first reactor. Two studies were conducted using the two reactor system. HCl concentrations were measured to be close to the 30% target. The first run had higher than desired chloride content. One possible cause was the high water flow rate through Fiber Reactor #2. In the final experiment run, Fiber Reactor #2 as operated with a lower water flow rate. Low water flow at a ratio of silicone to water roughly 4:1 was planned. Again, this sample appeared clean, had high product purity and good property measurements. The RI measurement was without drift and on target.

The chloride content of the silicone leaving Fiber Reactor #2 was higher than the original experiment. The water phase has considerably less HCl and the final silicone concentration was about 10 times higher in chlorides.

Similar techniques were also applied to a second monochlorosilane. Two experiments were conducted starting with dimethylvinylchlorosilane. Both experiments were conducted at 12.5% HCl concentrations. With less than 3 minutes of reaction contact time, the fiber reactor trial produced very low acid number material.

Table 1 contains many of the analytical results completed for the 10 experiments conducted using the fiber reactor as a chlorosilane hydrolysis reactor.

TABLE 1
List of experiments using the fiber reactor.

| Experiment | | | | GC % |
|---|---|---|---|---|
| Number | Sample # | ppm Cl | Acid # | purity |
| 1 | 23224-45 | 3.7 | | 99.33 |
| 2 | 23224-53 | 11.758 | | |
| 3 | 23224-57 | | | 99.08 |
| 6 | 23224-79 | 49.544 | | 99.22 |
| 7 | 23224-85 | 81.826 | | 99.33 |
| 8 | 23224-90 | 1.0411 | | |
| 9 | 23224-93 | 23.004 | | 99.07 |
| 10 | 23224-95-2 | | 0.0039 | |
| 10 | 23224-95-2 | | 0.0071 | |
| 10 | 23224-95-3 | | 0.0016 | |

The use of the fiber reactor as a reaction apparatus was found to be possible. Monochlorosilanes were successfully hydrolyzed to rapidly produce high purity silicones containing very small chloride constituents. The reaction was completed in less than 3 minutes time. With nondispersive mixing, a silicone of low chloride content can be obtained even when in contact with water containing high concentrations of HCl. Controlling the flow rates of the system allowed the HCl concentration to be controlled.

Furthermore, the hexamethyldisiloxane process was found to be improved by using the fiber reactor compared to certain conventional processes. With the fiber reactor process, a 44% reduction in the amount of water used can result. Also, the residence time could potentially be only 30 minutes with the fiber reactor process that includes washing.

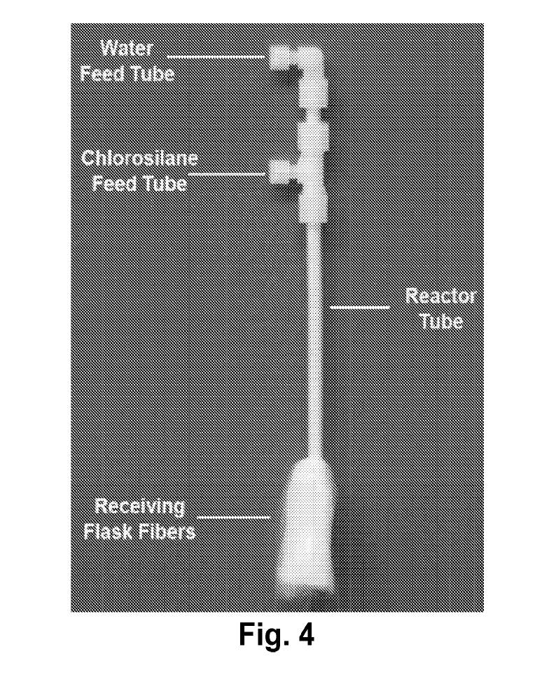

Additional details are describe below regarding the experiments listed in Table 1. The fiber reactors used in these experiments were made of fluorinated ethylene propylene (FEP) tubing (Nalgene 890, 8050-0500). The outer diameter (OD) was ½″, inner diameter (ID) was 7/16″ and the reactor straight tube length was 16″. There exists roughly 1″ additional contact length between the inlet tee and the start of the reactor (see FIG. 4). Fibers were Fisher Glass wool, 11388, a Pyrex® 9989 provided in a roving. In addition, the feed flasks were 5 L 3-neck flasks with bottom feed to pump, the feed pumps were Micropump G187 integral series magnetic drive gear pump (run by Camile), the feed meters were Micromotion CMF010N323Nu type units, and the collection flask was specially modified 500 mL separatory funnel with side draw hose barb.

The mass of the Pyrex® glass fibers, 8 microns in diameter, that were pulled into the tube was 9.37 g and extended for 26″. The fibers were pulled through using a copper wire wound around one end of the fibers. After pulling the wire through the reactor tube, the fibers were tugged gently to avoid breakage while simultaneously pushed without twisting or the assistance of water or solution. The fibers were as straight as possible within the tube. After the fibers are pulled into the tube, 4″ remained extended beyond the end of the reactor tube designated as receiving flask fibers. The task is made easier by next placing the wire through the chlorosilane feed tube, and after the fibers are fitted into the chlorosilane feed tube, the fibers were pulled into the water feed tube. The copper wire is removed and the fibers were trimmed.

For the fiber reactor labeled Fiber Reactor #22, the final mass of fibers was determined by weighing the difference between the final reactor tube mass and the initial empty tube mass. When combined with the fiber length measurement, a packing density can be determined. The packing density was 0.155 g/cc. This was because of the expected high amounts of water flow rate that may be necessary for the reaction. The void space was 93.1% of the overall tubing cross sectional area, and 134,000 fibers are estimated within this tube.

For the fiber reactor labeled Fiber Reactor #24, this reactor was constructed to be similar to Fiber Reactor #22 and was to be used to wash the residual chloride from the silicone fluid. The final mass of fibers was determined by weighing the difference between the final reactor tube mass and the initial empty tube mass. When combined with the fiber length measurement, a packing density can be determined. The packing density was 0.177 g/cc. The void space was 92.1% of the overall tubing cross sectional area, and 153,000 fibers are estimated within this tube.

### Experiment #1 (23224-45)

Reactor #22 was used along with trimethylchlorosilane as the chlorosilane. Electronics grade DI water was placed into the water feed flask. The feed rate of the water was set at 10.9 g/min. The chlorosilane feed was set at 5 g/min. HCl concentration target after reaction was 12.5%. Interstitial velocity is calculated to be 0.3 cm/sec. After the water feed was established and water touched the fibers in the separatory funnel, the chlorosilane feed was established. The reaction was detected because of the significant temperature rise, which was 24° C. The separatory funnel separated the materials well. The experiment lasted roughly 30 minutes.

### Experiment #2 (23224-53)

Reactor #22 was used along with trimethylchlorosilane as the chlorosilane. Electronics grade DI water was placed into the water feed flask. The feed rate of the water was set at 10.9 g/min. The chlorosilane feed was set at 5 g/min. Table 2 lists example flow rates during the experiment. After the water feed was established and water touched the fibers in the separatory funnel, the chlorosilane feed was established. The feed rate of the Me₃SiCl was 5 g/min. Temperature probes were placed every two inches below the chlorosilane feed inlet. After the feed was established, the water phase was removed so an accurate measure of the acid concentration could be made.

TABLE 2
Experimental flow rates and pressures

| | DI Water | | Chlorosilane | | |
|---|---|---|---|---|---|
| | Flowrate | Pressure | Flowrate | Pressure | |
| Time | (g/min) | (PSIG) | (g/min) | (PSIG) | Comments |
| 10:05 | 10.9 | | | | Water pump turned on |
| 10:10 | 10.9 | | 5 | | Chlorosilane pump turned on |
| 10:13 | | | | | Temperature increased |
| 10:10-10:18 | 10.9 | | | | Chlorosilane flowrate |
| | | | | | unsteady (air bubbles caught |
| | | | | | in pump) |
| 10:23 | | | | | Drained receiving flask of acid |
| | | | | | and water, left EBB phase |
| 10:30 | 11.1 | 4.1 | 4.8 | 3.6 | Max temp at 4″: 51° C. |
| 11:08 | 10.8 | 4.1 | 4.8 | 3.9 | |
| 11:39 | | | | | All pumps stopped |

### Experiment #3 (23224-57)

Reactor #22 was used along with trimethylchlorosilane as the chlorosilane. Electronics grade DI water was placed into the water feed flask. The feed rate of the water was set at 10.9 g/min. The feed rate of the Me₃SiCl was 5 g/min. After the water feed was established and water touched the fibers in the separatory funnel, the chlorosilane feed was established. Reaction was detected by the temperature increase that was measured. After the flow was well established, the flow ratios were changed. The water flow was decreased to 5.4 g/min. Immediately, the separatory funnel was emptied of the hexamethyldisiloxane. The separatory funnel separated the materials well.

### Experiment #4 (23224-67)

Reactor #22 was used along with trimethylchlorosilane as the chlorosilane. Electronics grade DI water was placed into the water feed flask. The feed rate of the water was set at 10.9 g/min. The feed rate of the Me₃SiCl was 5 g/min. After the water feed was established and water touched the fibers in the separatory funnel, the chlorosilane feed was established. Reaction was detected by the temperature increase that was measured. The separatory funnel contained 3 phases, but after a short time, there were only 2 phases.

### Experiment #5 (23224-72)

Reactor #22 was used along with trimethylchlorosilane as the chlorosilane. Electronics grade DI water was placed into the water feed flask. The feed rate of the water was set at 10.9 g/min. The feed rate of the Me₃SiCl was 5 g/min. Feeds were not steady and hard to control. After the water feed was established and water touched the fibers in the separatory funnel, the chlorosilane feed was established. Reaction was detected by the temperature increase that was measured. The separatory funnel separated the materials well. The experiment was run for 3 hrs.

### Experiment #6 (23224-79)

Reactor #22 was used along with trimethylchlorosilane as the chlorosilane. Electronics grade DI water was placed into the water feed flask. The feed rate of the water was set at 7 g/min. The feed rate of the Me₃SiCl was 9 g/minute to target a 30% HCl concentration in the water outlet stream. After the water feed was established and water touched the fibers in the separatory funnel, the chlorosilane feed was established. Reaction was detected by the temperature increase that was measured. Gas bubbles were observed in the fiber reactor. The separatory funnel separated the materials well. After the reaction was finished, Reactor #22 was used again. The silicone product from the fiber reactor was returned back to the chlorosilane feed flask. Silicone feed rate was set at 9 g/min and the water feed was 7 g/min. The phases separated well. Unexpectedly, the temperature probes detected a large increase in temperature, which reduced shortly after feeds began. Even though the feed flask was emptied, it was determined the pump, mass meter and feed lines to Reactor #22 still contained Me₃SiCl.

### Experiment #7 (23224-84, 23224-85)

Reactors #22 and #24 were used and trimethylchlorosilane was used. Electronics grade DI water was placed into the water feed flask. The feed rate of the water was set at 7 g/min. The feed rate of the Me₃SiCl was 9 g/minute to target a 30% HCl concentration in the water outlet stream. The total mass flow was set to be equivalent to the flow in Experiment #1. After the water feed was established and water touched the fibers in the separatory funnel, the chlorosilane feed was established. Reaction was detected by the temperature increase that was measured. Gas bubbles were observed in the fiber reactor. The separatory funnel separated the materials well. After flows were well established, the receiving flask was drained. This was done to enable the sampling of an aqueous phase that represents the water phase as it leaves the reactor. After the reaction was finished, Reactor #24 was used for washing. The silicone product from the Fiber Reactor #22 was placed into a feed flask. Silicone feed rate was set at 6.7 g/min and the water feed was 7 g/min. As a two stage reactor, water flow to Reactor #24 was set at the identical 7 g/min. After using the water for washing, the same water could be fed to Reactor #22 for reaction water. The phases separated well.

### Experiment #8 (23224-90)

Reactor #22 was used and dimethylvinylchlorosilane (4-2775) was used. Electronics grade DI water was placed into the water feed flask. The feed rate of the water was set at 9.8 g/min. The chlorosilane feed was set at 5 g/min. These rates were set for a total flow rate of roughly 16 g/min and an HCl concentration after reaction of 12.5%. After the water feed was established and water touched the fibers in the separatory funnel, the chlorosilane feed was established. The separatory funnel separated the materials well. The experiment lasted roughly 2 hours.

### Experiment #9 (23224-92, 23224-93)

Reactors #22 and #24 were used and trimethylchlorosilane was used. Electronics grade DI water was placed into the water feed flask. The feed rate of the water was set at 7 g/min. The feed rate of the Me₃SiCl was 9 g/minute to target a 30% HCl concentration in the water outlet stream. The total mass flow was set to be equivalent to the flow in Experiment #1. After the water feed was established and water touched the fibers in the separatory funnel, the chlorosilane feed was established. Reaction was detected by the temperature increase that was measured. Gas bubbles were observed in the fiber reactor. The separatory funnel separated the materials well. After flows were well established, the receiving flask was drained. This was done to enable the sampling of an aqueous phase that represents the water phase as it leaves the reactor. After the reaction was finished, Reactor #24 was used for washing. The silicone product from the fiber Reactor #22 was placed into a feed flask. Silicone feed rate was set at 6.7 g/min and the water feed was 2 g/min. The phases separated well. The chloride content was good at 23 ppm.

### Experiment #10 (23224-95)

Reactor #22 was used and dimethylvinylchlorosilane was used. Electronics grade DI water was placed into the water feed flask. The feed rate of the water was set at 9.8 g/min. The chlorosilane feed was set at 5 g/min. Table 3 lists example flow rates and pressures during the experiment. These feed rates are set to give a final HCl concentration in the outlet water of 12.5%. After the water feed was established and water touched the fibers in the separatory funnel, the chlorosilane feed was established. The separatory funnel separated the materials well.

TABLE 3
Experimental flow rates and pressures

| | DI Water | | Chlorosilane | | |
|---|---|---|---|---|---|
| | Flowrate | Pressure | Flowrate | Pressure | |
| Time | (g/min) | (PSIG) | (g/min) | (PSIG) | Comments |
| 11:08 | 9.8 | | | | Water pump on |
| 11:12 | | | | | Water pump to 40% output to flush the |
| | | | | | tubing; black substance present |
| 11:14 | 9.8 | | | | Water pump on |
| 11:33 | | | 5 | | Chlorosilane valve opened |
| 11:51 | 9.9 | 3.7 | 5.1 | 3.1 | |
| 12:22 | 9.9 | 3.8 | 5.3 | 3 | Chlorosilane flowrate jumps around |
| | | | | | Sample 23224-95-1 of 4-2776 taken |
| 12:48 | 9.6 | 3.8 | 5.1 | 3 | Sample 23224-95-2 of 4-2776 taken |
| 13:04 | 9.9 | 3.9 | 4.6 | 3 | Sample 23224-95-3 of 4-2776 taken |
| 13:18 | 9.9 | 3.8 | 5.1 | 3 | Sample 23224-95-4 of 4-2776 taken and |
| | | | | | sample 23224-95-5 of acid taken |
| 13:19 | | | | | Chlorosilane valve closed |
| 13:34 | | | | | Water off |

### Example 2

### Hydrolysis of PhMeSiCl

Hydrolysis of PhMeSiCl in a fiber filled tube was performed. The fiber tube was constructed using ½ inch OD FEP tubing and 0.008 millimeter diameter Pyrex® glass fibers. The tube was 33 inches long and had a packed tube density of 0.35 g/inch. The hydrophilic fibers could provide more surface area for the hydrolysis to occur. Once the reaction occurred, the free chloride would also migrate to the water phase allowing for a fast phase separation in the separation vessel. Initially, two variables including % HCl and flow rate (residence time) were varied. Ranges were selected based on reasonable operating parameters and lab capability.

With low acid concentration (12% HCl), siloxanes favored linears over cyclics. With middle acid concentration (24% HCl), siloxanes favored cyclics and high boilers. With high acid concentration (36% HCl), siloxanes favored cyclics and high boilers, similar to middle acid concentration results. Flow has a smaller effect, and in general, lower flow made more high boilers and less linears. Higher flow rates had the opposite effect making more linear and less high boilers. In conclusion, a hydrolysis steam containing of 800 ppm residual chloride and PhMe siloxanes comprised of linears, cyclics and high boiling PhMe siloxanes were able to be generated.

### Example 3

### Polymerization

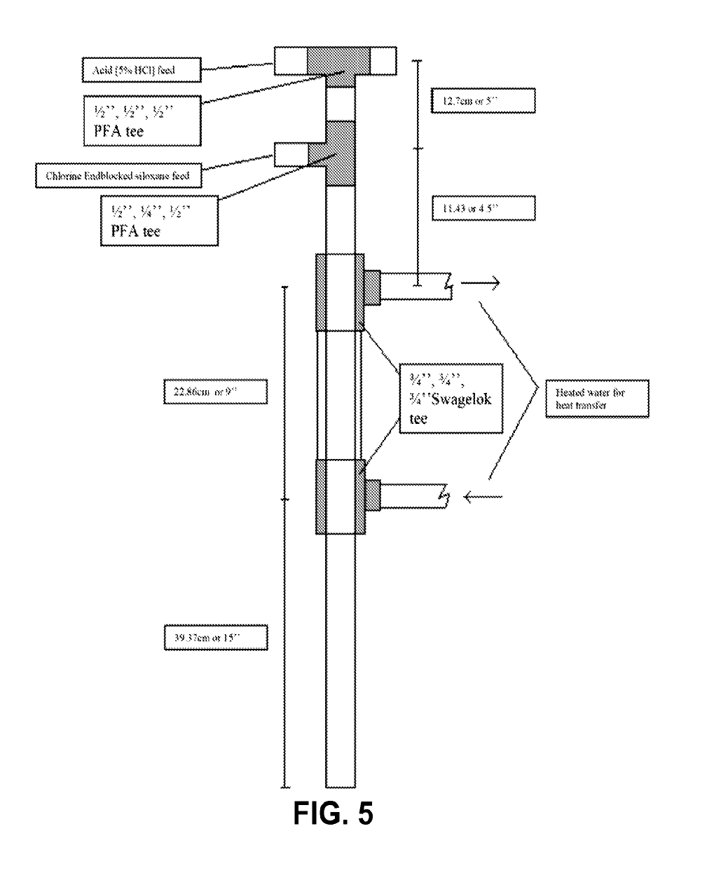

This example illustrates the use of an apparatus according to FIG. 5 to perform the reaction of a chlorine endblocked dimethyl hydrolysate stream with ˜5 wt % aqueous hydrochloric acid to promote the condensation polymerization of the chlorine endblocked dimethyl hydrolysate into a longer chained, hydroxyl (—OH) endblocked siloxane fluid of higher Number Average Molar Mass (Mn). The apparatus of this example comprised a 0.95 cm nominal inner diameter Teflon® PFA (Copolymer of Tetrafluoro Ethylene and Perfluoroalkyl Vinyl Ether) conduit of length 86.36 cm containing approximately 150,000 hydrophilic Pyrex® Glass Wool Roving 9989 fibers. The fibers were 8.0 μm in diameter, approximately 93 cm in length, packed along the entire length of the conduit reactor, and had approximately 6 cm extending out of the downstream end of the conduit reactor into a separatory vessel. The conduit reactor apparatus contains a 1.27 cm×1.27 cm×1.27 cm (½″×½″×½″) diameter Teflon® PFA tee, attached to the top inlet end of the conduit reactor. A feed line for the ˜5 wt % aqueous hydrochloric acid is attached to this top Teflon® PFA tee. A second Teflon® PFA tee of diameter 1.27 cm×0.635 cm×1.27 cm (½″×¼″×½″) was installed 12.7 cm below the top Teflon® PFA tee at the top end of the conduit reactor. A feed line for the chlorine endblocked dimethyl hydrolysate was attached to this lower Teflon® PFA tee. The entire conduit reactor length was 86.36 cm.

A tube heat exchanger was constructed onto the conduit reactor to provide constant heat into the conduit reactor. The tube heat exchanger was approximately 22.86 cm in total length, and constructed from two 1.905 cm diameter Swagelok® stainless steel tees with a separate conduit of 1.905 cm diameter jacketing the inner conduit of the conduit reactor. The tube heat exchanger was located 11.43 cm below the second feed Teflon® PFA tee. Heated water was pumped through the tube heat exchanger from the bottom of the tube heat exchanger to the top, providing constant heat input to the conduit reactor. The remaining 39.37 cm of fiber filled conduit reactor leading into the separatory vessel was unheated.

Hot water temperature was controlled at 75° C. and was circulated through the tube heat exchanger of the conduit reactor to maintain conduit reactor temperature. Table 4 lists the hot water inlet and exit temperatures. The ˜5 wt % aqueous hydrochloric acid was preheated to the temperature listed in Table 4 and was introduced into the apparatus conduit at the upstream end of the Pyrex® Glass Wool fibers as the first liquid. After the ˜5 wt % aqueous hydrochloric acid flow was initiated, a second liquid comprising of chlorine endblocked dimethyl hydrolysate (Number Average Molar Mass listed in Table 4 and comprising approximately 50% dimethyl cyclic siloxane and 50% chlorine endblocked dimethyl siloxane) was preheated to the temperature listed in Table 4 and was introduced into the conduit at the upstream end of the fibers through the side inlet of the tee.

The ˜5% aqueous hydrochloric acid first liquid and chlorine endblocked dimethyl hydrolysate second liquid underwent the condensation polymerization reaction within the conduit reactor to produce the longer chained, hydroxyl (—OH) endblocked siloxane fluid of higher Number Average Molar Mass (Mn). The aqueous hydrochloric acid and hydroxyl (—OH) endblocked dimethyl siloxane fluid exited the conduit reactor and was collected in the separatory vessel at the downstream end of the fibers. The final temperature of the product stream in the separatory vessel is listed in Table 4. Four experimental runs were performed varying the contact time. The flow rate ratio of the chlorine endblocked dimethyl hydrolysate to the ˜5% aqueous hydrochloric acid was kept constant at 4:1. The hydrochloric acid and hydroxyl (—OH) endblocked dimethyl siloxane streams exited the conduit reactor as separate phases. No settling time was required in the separatory vessel as there was instantaneous separation of the polymerized hydroxyl (—OH) endblocked dimethyl siloxane fluid and hydrochloric acid phases.

Samples of the feed chlorine endblocked dimethyl hydrolysate stream prior to entering the conduit reactor was analyzed for Number Average Molar Mass (Mn) via Gel Permeation Chromatography (GPC). Samples of the final product hydroxyl (—OH) endblocked dimethyl siloxane were obtained from the collection vessel and analyzed for Number Average Molar Mass (Mn) via GPC. Data results for the Mn build as a result of the condensation polymerization reaction are listed in Table 4.

TABLE 4
Condensation Polymerization Reaction of chlorine endblocked dimethyl
hydrolysate with hydrochloric acid in an apparatus comprising hydrophilic Pyrex ®
Glass wool fibers

| | | | | | | Residence | |
|---|---|---|---|---|---|---|---|
| | | | | Chlorine | Residence | Time | |
| | | Chlorine | | Endblocked | Time | Throughout | |
| | 5% | Endblocked | | Dimethyl | Throughout | Heated | |
| | Aqueous | Dimethyl | 5% Aqueous | Hydrolysate | Complete | Section of | 5% Aqueous |
| | HCl | Hydrolysate | HCl Feed | Feed Line | Conduit | Conduit | HCl Feed |
| | Flowrate | Flowrate | Line Pressure | Pressure | Reactor | Reactor | Temperature |
| Sample | (ml/min) | (ml/min) | (psig) | (psig) | (minutes) | (minutes) | (deg C.) |
| 1 | 1 | 4 | 0.25 | 0.5 | 11.8124 | 3.1268 | 70.25 |
| 2 | 1 | 4 | 0.5 | 0.5 to 1 | 11.8124 | 3.1268 | 70.9 |
| 3 | 2 | 8 | 1 to 2 | 2 | 5.9062 | 1.5634 | 70.5 |
| 4 | 4 | 16 | 4 to 6.5 | 5 to 8.5 | 2.9531 | 0.7817 | 72 |

| | | | | | | Final Mn of | |
|---|---|---|---|---|---|---|---|
| | Chlorined | | | | | the Product | |
| | Endblocked | | | | Initial Mn of | Hydroxyl | |
| | Dimethyl | | | | Feed Chlorine | (—OH) | |
| | Hydrolysate | Heating | Heating | Separatory | Endblocked | Endblocked | |
| | Feed | Water Inlet | Water Outlet | Vessel | Dimethyl | Dimethyl | |
| | Temperature | Temperature | Temperature | Temperature | Hydrolysate | Siloxane Fluid | Mn Increase |
| Sample | (deg C.) | (deg C.) | (deg C.) | (deg C.) | (g/mol) | (g/mol) | (g/mol) |
| 1 | 26.5 | 75 | 66.1 | 71.1 | 1045.4 | 2219.8 | 1174.4 |
| 2 | 26.5 | 75 | 66.7 | 70.56 | 1054.3 | 2832.8 | 1778.5 |
| 3 | 36.8 | 75 | 65 | 75.5 | 1127.9 | 1849.6 | 721.7 |
| 4 | 35.9 | 75 | 64 | 72.3 | 1061 | 1462.9 | 401.9 |

### Example 4

### Removal of Silicones from Aqueous Hydrochloric Acid

This example illustrates the use of an apparatus according to FIG. 1 to treat an aqueous hydrochloric acid stream with organic solvents (toluene and heptane) to remove silicones from the aqueous hydrochloric acid. The apparatus of this example comprised a 0.95 cm nominal inner diameter fluorinated ethylene propylene (FEP) Teflon conduit of length 53.34 cm containing approximately 168,000 Glass Wool Pyrex® fibers. The fibers were 8 μm in diameter, approximately 63.5 cm in length, packed tightly along the entire length of the conduit, and had approximately 10 cm extending out of the downstream end of the conduit into a separatory funnel. A 0.95 cm FEP Teflon tee was attached approximately 11.4 cm from the inlet end of the conduit. Aqueous hydrochloric acid contaminated with silicon material feed line was attached at the inlet and organic solvent (either toluene or heptane) feed line was attached at the tee.

Aqueous hydrochloric acid contaminated with silicon material flow was introduced into the apparatus conduit at the upstream end of the Pyrex® glass fibers as the first liquid. After the aqueous hydrochloric acid contaminated with silicon material flow was started, a second liquid comprising of organic solvent (either toluene or heptane) was introduced into the conduit through the side inlet of the tee, contacting the fibers. The aqueous hydrochloric acid contaminated with silicon material first liquid and organic solvent (either toluene or heptane) second liquid were collected in the separatory funnel at the downstream end of the fibers. Two experimental runs were performed varying the aqueous hydrochloric acid contaminated with silicon material from different sources. The flow rate ratio of the organic solvent (either toluene or heptane) to aqueous hydrochloric acid contaminated with silicon material was varied from 1.1:1 to 1.6:1. The organic solvent (either toluene or heptane) and aqueous hydrochloric acid contaminated with silicon material streams exited the conduit as separate phases. No settling time was required in the separatory funnel as there was instantaneous separation of the organic and aqueous phases. Samples of the aqueous hydrochloric acid stream contaminated with silicon material stream prior to entering the conduit and from the collection vessel were analyzed by atomic adsorption spectroscopy to determine the silicon concentration. All testing was performed at 25° C. The flow rates, pressures, contact time and silicon material removal efficiency are listed in Table 5.

TABLE 5
Treatment of aqueous hydrochloric acid contaminated with silicon material with
organic solvent (either toluene or heptane) in an apparatus comprising glass fibers

| Aqueous | | | | | | | | |
|---|---|---|---|---|---|---|---|---|
| Hydrochloric | Nominal | | | | | | | |
| Acid | aqueous | Nominal | | Aqueous | | Inlet | Outlet | Silicon |
| contaminated | hydrochloric | organic | | Hydrochloric | | Concentration | Concentration | material |
| with silicon | acid | solvent | | acid line | Residence | of silicon | of silicon | removal |
| material | flowrate | flowrate | Organic | pressure | Time | material | material | efficiency |
| source | (ml/min) | (ml/min) | solvent | (psig) | (min.) | (ppm) | (ppm) | (%) |
| 1 | 3.7 | 4.1 | Toluene | 6 | 5.1 | 2372 | 84 | 96.5 |
| 2 | 1.7 | 2.7 | Heptane | 10 | 9.1 | 1265 | 173 | 86.3 |

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A method of reacting compounds comprising:
flowing a first liquid comprising a first compound into an inlet of a conduit and through a fiber bundle comprising a plurality of fibers extending lengthwise in the conduit;
flowing, while flowing the first liquid, a second liquid comprising a second compound having at least one silicon atom into the inlet of the conduit and through the fiber bundle;
reacting the first compound and the second compound within the fiber bundle to produce a third compound having at least one silicon atom; and
flowing the third compound out an outlet of the conduit.

2. The method of claim 1, wherein the first liquid and the second liquid are substantially immiscible.

3. The method of claim 1, wherein the plurality of fibers are selected to be preferentially wetted by the first liquid than the second liquid.

4. The method of claim 1, further comprising forming a third liquid comprising the third compound within the fiber bundle; and flowing the third liquid out the outlet of the conduit.

5. The method of claim 4, further comprising forming a fourth liquid within the fiber bundle; and flowing the fourth liquid out the outlet of the conduit.

6. The method of claim 5, further comprising collecting the third liquid and the fourth liquid in a collection vessel, wherein the third liquid forms a first layer and the fourth liquid forms a second layer in the collection vessel.

7. The method of claim 6, further comprising:
flowing a fifth liquid an inlet of a second conduit and through a second fiber bundle comprising a plurality of fibers extending lengthwise in the second conduit; and
flowing, while flowing the fifth liquid, the third liquid into the inlet of the second conduit and through the second fiber bundle.

8. The method of any of claim 1, wherein the first compound comprises water, the second compound comprises at least one chlorosilane, and the third compound comprises a siloxane.

9. The method of claim 8, wherein the reacting the first compound and the second compound further produces a fourth compound comprising hydrogen chloride.

10. The method of claim 8, wherein the siloxane comprises hexamethyldisiloxane.

11. The method of claim 8, wherein the at least one chlorosilane comprises a monochlorosilane.

12. The method of claim 11, wherein the monochlorosilane comprises trimethylchlorosilane.

13. The method of claim 11, wherein the monochlorosilane comprises dimethylvinylchlorosilane.

14. The method of claim 1, wherein the second compound comprises at least one siloxane having a first number average molar mass.

15. The method of claim 14, wherein the third compound comprises a polymerized siloxane having a second number average molar mass greater than the first number average molar mass.

16. The method of claim 14, wherein the reacting the first compound and the second compound comprises polymerizing.

17. The method of claim 14, wherein the at least one siloxane comprises dimethyl cyclic siloxane and chlorine endblocked dimethyl siloxane.

18. The method of claim 14, wherein the first liquid comprises aqueous hydrochloric acid.
